(19) United States
(12) Patent Application Publication
(10) Pub. No.: US 2024/0333398 A1
(43) Pub. Date: Oct. 3, 2024

(54) System and Method for Implementing Quantum-Secure Wireless Networks

(71) Applicant: General Electric Company, Schenectady, NY (US)

(72) Inventor: Stephen Francis BUSH, Latham, NY (US)

(73) Assignee: General Electric Company, Schenectady, NY (US)

(21) Appl. No.: 18/579,254

(22) PCT Filed: Jul. 14, 2022
(86) PCT No.: PCT/US2022/037143

§ 371 Date: Jan. 12, 2024

Related U.S. Application Data
(60) Provisional application No. 63/221,802, filed on Jul. 14, 2021.

(51) Int. Cl. H04B 10/70

(52) U.S. Cl. CPC H04B 10/70

(57) ABSTRACT

At a wireless communication network including subcomponents, a connection establishment message from a user equipment is received to connect the user equipment to the wireless communication network. From a wireless key distribution device, via. a. quantum communication channel, quantum encryption keys are received to encrypt and decrypt messages communicated with the user equipment, A network connection between the user equipment and the wireless communication network is established, and for at least one subcomponent of the wireless communication network: incoming communications from the user equipment or the other sub-components are decrypted using the quantum encryption keys and a quantum key distribution algorithm; and outgoing communication to the user equipment or the other subcomponents are encrypted using the quantum encryption keys and the quantum key distribution algorithm.

### CROSS-REFERENCE TO RELATED APPLICATIONS

This application claims priority to U.S. Provisional Patent Application No. 63/221,802, filed Jul. 14, 2021, which is incorporated herein by reference in its entirety.

### TECHNICAL FIELD

The present disclosure generally relates to wireless communication networks and, more particularly, to quantum-secure wireless networks.

### BACKGROUND

As computer processing speed increases, the ability to securely exchange information may become compromised. Even more concerning is the fact that classical data security techniques may be less likely to detect eavesdroppers observing cryptographic keys. Further, as quantum computing evolves, classical asymmetric key distribution for secure communication may not suffice. There is a need for more secure wireless communications systems (including, e.g., alternative mechanisms of quantum-resistant protection) that can interact with devices and network equipment without compromising features related to encryption, authentication, confidentiality, integrity, non-repudiation, provenance, and the like.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method of quantum-secure communications at a wireless communication network (e.g., a 4G/LTE, 5G network and/or other networks configured in accordance with one or more international wireless communication standards) including subcomponents, each subcomponent being communicatively coupled to at least one other subcomponent: receiving, via a wireless communication, from a user equipment, a connection establishment message to connect the user equipment to the wireless communication network; receiving, from a wireless key distribution device via an optical communication channel, quantum encryption keys to encrypt and decrypt messages communicated with the user equipment; establishing a network connection between the user equipment and the wireless communication network; and for at least one subcomponent of the wireless communication network. The communications also includes decrypting incoming communications from the user equipment or the other subcomponents using the quantum encryption keys and a quantum key distribution (QKD) algorithm; and encrypting outgoing communication to the user equipment or the other subcomponents using the quantum encryption keys and the quantum key distribution algorithm. Other embodiments of this aspect include corresponding computer systems, apparatus, and computer programs recorded on one or more computer storage devices, each configured to perform the actions of the methods.

Implementations may include one or more of the following features. The method may include: distributing, via the wireless key distribution device, the quantum encryption keys to the user equipment. The subcomponents of the wireless communication network include a radio unit (RU), a distributed unit (DU), a centralized unit (CU) and a core network. Each subcomponent may be configured to encrypt and decrypt communications using the quantum encryption keys and the quantum key distribution algorithm. The wireless key distribution device may be a satellite, an aerospace vehicle (e.g., drone, balloon, aircraft, etc.), free-space optical communication device, millimeter wave communication device, microwave communication device, visible light communication device, or the like. The wireless communication system (e.g., a 5G network) includes a plurality of network slices (configured in accordance with the 5G standard specification), where a (5G) network slice may be associated with at, least, one of the quantum encryption keys. Network slices may reside over a satellite, which may serve as a quantum key distribution satellite. Such slices may be referred to as “quantum key distribution network slices” for delivering keys. In other words, a network slice may be defined purely to distribute quantum key distribution keys. Stated yet another way, a network slice may be set up through a satellite, and that network slice may be dedicated to distributing (or supporting the distribution of) quantum key distribution keys.

Quantum key distribution may use a classical (non-quantum) channel and a quantum channel. One or both of the classical and quantum channels may be “sliced” via time or frequency multiplexing. Each such slice (representing the classical or quantum channel) may be associated with, and act as, part of a network slice implemented in a 5G network. The classical channel may support the quantum channel because there is some classical processing and exchanges that occur as part of quantum key distribution. These channels may be implemented over dedicated slices. Once a final quantum key is generated, it may be distributed over a respective dedicated slice. Since quantum key distribution is a physical process (involving the use of hardware to generate and distribute quantum keys) and network slices are virtual (involving software and virtualized abstractions), it is desirable to keep encryption keys in a quantum state and localized to respective devices until needed in order to avoid vulnerabilities inherent in passing classical keys around.

The method may further include: establishing the network connection between the user equipment and the wireless communication network using a first network slice of the plurality of network slices; and for at least one subcomponent of the wireless communication system (e.g., for an RU, CU, and/or DU included in a satellite): decrypting incoming communications from the user equipment or the other subcomponents using the at least one of the quantum encryption keys associated with the first network slice and the quantum key distribution algorithm; and encrypting outgoing communication to the user equipment or the other subcomponents using the at least one of the quantum encryption keys associated with the first network slice and the quantum key distribution algorithm. As such, a satellite may contain one or more radio access network (RAN) processing units such as an RU, CU, and/or DU that can be protected by quantum key distribution. Implementations of the described techniques may include hardware, a method or process, or computer software on a computer-accessible medium.

### BRIEF DESCRIPTION OF THE DRAWINGS

The foregoing summary, as well as the following detailed description of embodiments of the invention, will be better understood when read in conjunction with the appended drawings of an exemplary embodiment. It should be understood, however, that the invention is not limited to the precise arrangements and instrumentalities shown.

In the drawings:

FIGS. 1A-1C are conceptual views of a wireless communication system in accordance with exemplary embodiments of the present disclosure;

FIG. 2 is a flow chart illustrating a method for implementing a wireless communication system in accordance with an exemplary embodiment of the present disclosure; and

FIG. 3 is a flow chart illustrating a method for implementing quantum-secure communications in a wireless communication system in accordance with an exemplary embodiment of the present disclosure.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

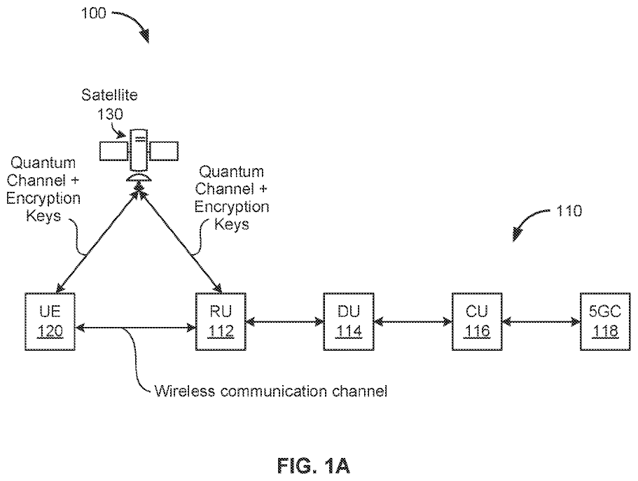

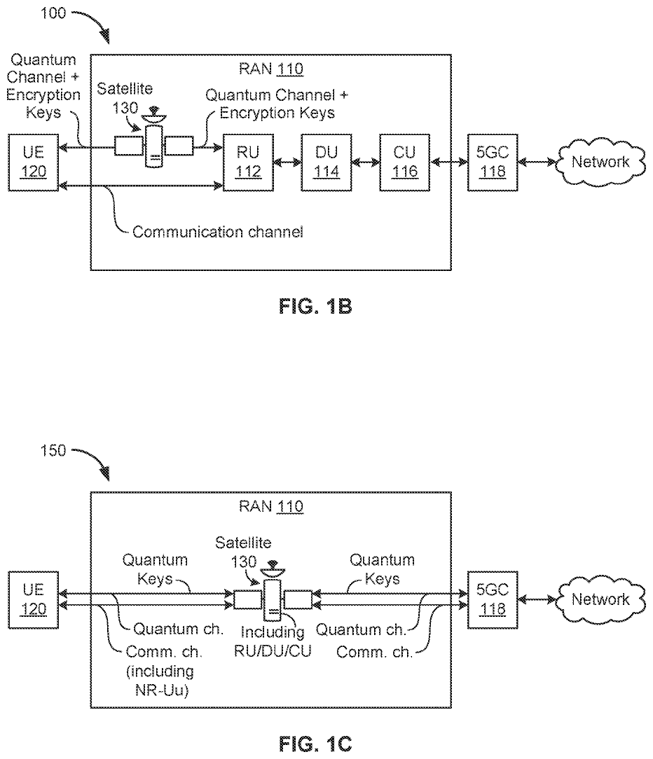

FIG. 1A illustrates a wireless communication system 100 according to an embodiment of the disclosure.

The wireless communication system 100 may include a wireless communication network 110. The wireless communication network 110 is configured to provide wireless communication functionality as described in further detail herein. The wireless communication network 110 may be implemented as a radio access network (RAN).

The wireless communication system 100 may include user equipment (UE) 120, including a universal subscriber identity module (USIM). The UE 120 is a device used by a user, and performs communication with the wireless communication network 110 via the radio channel. A link from the wireless communication network 110 to the UE 120 is referred to as a downlink (DL), and a link from the UE 120 to the wireless communication network 110 is referred to as an uplink (UE). The UE 120 may communicate with other UEs (not shown) via the wireless communication network 110. In some cases, the UE 120 may be operated without involvement of a user. That is, the UE 120 may be a device that performs machine type communication (MTC) and may not be carried, by a user. The UE 120 may be referred to herein as “terminal”, “customer premises equipment (CPE)”, “mobile station”, “subscriber station”, “remote terminal”, “wireless terminal”, “electronic device”, “user device”, or other terms having equivalent technical meanings. The UE 120 may include a universal subscriber identity module (USIM). The USIM may securely store and handle some or all of the sensitive data related to the subscriber and the home network. The USIM may be under the control of the home network operator: the home network operator may choose the data to be provisioned in the USIM before the issuance of the universal integrated circuit card (UICC) and administrate remotely the USIM in the user equipment using Over-The-Air (OTA) mechanisms. The USIM may be a trust anchor in the user equipment. The USIM may provide initial authentication for quantum key distribution connections. In other words, the USIM may be used as a way to ensure that a quantum key distribution device is legitimate by starting the quantum key distribution initial authorization of the quantum key distribution device. In some implementations, QKD may utilize a post-quantum cryptographic (PQC) protocol such as crystals-dilithium to perform authentication for QKD. Quantum key distribution can either work with an existing 5G key specification (augmenting it) or in place of it in at least some portions of the network. In other words, quantum key distribution can replace classical key distribution mechanisms, or can be used in addition to classical key distribution mechanisms. As such, a particular 5G standard may specify a means of identifying where quantum key distribution is being used. Generally, quantum key distribution utilizes a quantum channel or fiber to distribute cryptographic keys for use in securing messages. Quantum mechanics of photons are used to generate and distribute keys. Because observation of a quantum system disrupts the system, eavesdroppers may be reliably detected. In some implementations, suspicious activity discovered by QKD, e.g., a high quantum error bit rate, may automatically cause a new key to be issued (i.e., a “key update”) and/or the key update rate to increase.

In some embodiments, the UE 120 is connected to a time-sensitive network (TSN) or a 5G network implemented with and supporting a TSN. The time-sensitive network may be quantum protected.

The wireless communication network 110 may include a radio unit 112. The radio unit 112 provides a wireless communication channel (e.g., radio communication) with external devices, including UE 120. The radio unit 112 has a coverage area defined to be a predetermined geographic area based on the distance over which a radio signal may be transmitted. The radio unit 112 may also be referred to herein as base station, access point (AP), eNodeB (eNB), 5G node (5th generation node), next generation nodeB (gNB), wireless point, transmission/reception point (TRP), or other terms having equivalent technical meanings.

The wireless communication network 110 may include a digital processing unit (DU) 114. A fronthaul between the DU 114 and the RU 112 may be operated via an Fx interface. For the operation of the fronthaul, for example, an interface, such as an enhanced common public radio interface (eCPRI) and radio over Ethernet (ROE), may be used. In some embodiments, the fronthaul interface may include optical communication between components. Quantum key distribution keys may be used to protect interface data transferred over fronthaul, backhaul, and/or crosshaul interfaces.

The DU 114 may be implemented to perform functions for a packet data convergence protocol (PDCP), a radio link control (RLC), a media access control (MAC), and a physical (PHY) layer, and the RU may be implemented to perform more functions for a PHY layer in addition to a radio frequency (RF) function. The DU 114 may reside on the satellite and there may exist inter-satellite communications for longer 5G paths.

The DU 114 may be control an upper layer function of a radio network. For example, the DU 160 may perform a function of a MAC layer and a part of a PHY layer. In some embodiments, a part of the PHY layer is a function performed at a higher stage from among functions of the PHY layer, and may include, for example, channel encoding (or channel decoding), scrambling (or descrambling), modulation (or demodulation), and layer mapping (or layer demapping). According to an embodiment, if the DU 114 conforms to the O-RAN standard, it may be referred to as an O-RAN DU (O-DU). The DU 114 may be replaced with and represented by a first network entity for the base station (e.g., gNB) in embodiments of the disclosure as needed. Quantum key distribution may provide for improving the randomness of processes like back-off. Specifically, for Random Access Channel (RACH) implementations, the initial RACH connection may require random choices and data that can come from quantum sources like quantum key distribution for “true” randomness, which can help avoid collisions. For example, QKD keys are random numbers and random number generation (QRNG) is part of QKD. Thus key material can be used to created improved entropy as needed for random back-off and other applications, where randomness is required and critical.

The RU 112 may be in charge of a lower layer function of the radio network. For example, the RU 112 may perform a part of the PHY layer and the RF function. Here, a part of the PHY layer is a function performed at a relatively lower stage compared to the DU 114 from among the functions of the PHY layer, and may include, for example, an inverse fast Fourier transform (IFFT) transformation (or FFT transformation), cyclic prefix (CP) insertion (CP removal), and digital beamforming. According to an embodiment, if the RU 112 conforms to the O-RAN standard, it may be referred to as an O-RAN RU (O-RU). The RU 112 may reside on the satellite. Quantum key distribution may reside, in a rather transparent manner, close to the PHY layer as an integral part of the 5G system for protecting lowest-layer traffic flow. Both the UE 120 and RU/gNB have the option of connecting to satellite and/or terrestrial fiber for quantum key distribution. In other words, quantum key distribution may occur over satellite link(s), terrestrial communication link(s), or a hybrid combination of satellite and terrestrial communication links.

The wireless communication network 110 may include a centralized unit (CU) 116. The CU 116 may be configured to perform a function of an upper layer (e.g., packet data convergence protocol (PDCP) and RRC) of an access network and the DU 114 may be configured to perform a function of a lower layer. A midhaul interface between the CU 116 and the DU 114 may be referred to as an F1 interface. In some embodiments, the midhaul interface may include optical communication between components. All or a subset of interfaces (not just F1) may be protected by quantum key distribution.

The wireless communication network 110 may include a core network (5GC) 118. The core network may be configured to provide network communications to the UE 120 (including a USIM card as discussed above) as well as any other devices connected to the wireless communication network 110. In some embodiments, the core network 118 is a service-based architecture (SBA) that supports authentication, security, session management and/or aggregation of traffic from connected devices, all of which requires the complex interconnection of network functions. The core network 118 is connected to the CU 116 via a backhaul interface. In some embodiments, the backhaul interface may include optical communication between components.

The core network 118 may include a number of management functions in the SBA. For example, the core network 118 may include an Access and Mobility Management Function (AMF) configured to handle access control and mobility amongst others. AMF may also integrate network slice selection functionality as part of its basic set of functions. AMF may specify how to handle intermittent quantum key distribution connectivity. For example, AMF may specify the use of buffer keys (classically or via quantum memory), the use of satellite(s), and so forth.

In some embodiments, the satellite may be replaced with other methods of generating and distributing quantum key distribution, including mm wave, microwave, single photons for performing quantum key distribution over links including mm waves and/or microwaves (e.g., using a mm/microwave base station instead of a satellite). In such scenarios, keys may be stored on both sides in order to use them during intermittent down time (e.g., during a storm).

The core network 118 may include a User plane Function (UPF). UPF is configured for packet routing and forwarding, packet inspection, QoS handling, and external protocol data unit (PDU) session for interconnecting data networks including operator services, Internet access, or 3rd party services. Quantum key distribution key rate statistics may be exposed for decisions regarding security versus performance tradeoffs. For example, the longer time duration that keys are used (before updating with a new key), the longer an adversary/intruder has to attempt to break the operational current key. Changing keys more frequently requires an attacker to compute faster to break the key. This may be an enhanced 5QI to QoS Mapping table element. Specifically, the core network 118 may be constrained by the rate at which keys can be generated versus the rate keys are desired to be used to provide security, so QoS handling can be added to specify user preferences in terms of security versus key rates that can be supported in a given network.

The core network 118 may include an Authentication Server Function (AUSF) configured to allow the AMF to authenticate the UE and access services of the core network 118.

The core network 118 may include an Session Management Function (SMF). The SMF is setup according to the network policy to handle user sessions. The policy may encourage or require use of quantum key distribution.

The core network 118 may include a Network Slice Selection Function (NSSF) configured to select a network slicing instance (NSI), determine the allowed network slice selection assistance information (NSSAI), and set AMF to serve the UE 120. NSSF may have optional quantum key distribution parameters for enhanced security.

The core network 118 may include an Network Exposure Function (NEF) configured to securely expose the services and capabilities of the core network 118 to the UE 120. Quantum key distribution may be an exposed service. For example, whether devices in this NEF function support quantum key distribution may be discoverable.

The core network 118 may include an NF Repository Function (NRF). The NRF provides registration and discovery functionality allowing network functions (NFs) to discover each other and communicate via open APIs. Quantum key distribution may be discovered functionality.

The core network 118 may include an Policy Control function (PCF). The PCF is configured to implement a policy framework for network slicing. The PCF may require quantum-resistant protection via quantum key distribution. In other words, the PCF may require quantum resistance, in which case post-quantum cryptography (PQC) or quantum key distribution may be used.

The core network 118 may include an Unified Data Management (UDM). The UDM is configured to integrate subscriber information for both fixed and mobile accesses in NG core.

The core network 118 may include an Application Function (AF) configured to implement an application-specific policy framework. A time-sensitive network (TSN) may be exposed via an AF. The AF may expose whether TSN is protected via quantum key distribution. Quantum key distribution may provide protection for quantum key distribution and also be exposed via an AF.

In some implementations, wireless communication network 110 may implement network slicing. Network slicing allows a network operator to provide dedicated virtual networks with functionality specific to the service or customer over a common network infrastructure. Thus, network slicing supports numerous and varied services envisaged in time sensitive networks. A network slice may optionally be dedicated to supporting the classical quantum key distribution connection. Such a slice may be referred to as a quantum key distribution slice.

More specifically, network slicing is a form of virtual network architecture using principles behind software defined networking (SDN) and network functions virtualization (NFV) in fixed networks. Quantum key distribution may be managed via similar SDN concepts including a YANG model. SDN and NFV deliver network flexibility by allowing traditional network architectures to be partitioned into virtual elements that can be linked (additionally or alternatively through software). While the quantum operations of quantum key distribution cannot be virtualized, quantum key distribution processing functions may be virtualized. For example, qubits may be held in quantum memory, and virtualized classical processing of those qubits may be virtualized.

Network slicing allows multiple virtual networks to be created on top of a common shared physical infrastructure. The virtual networks may be customized to meet the specific needs of applications, services, devices, customers or operators.

in the case of time sensitive networks using the principles described above with reference to network system 100 (e.g., Ethernet, 5G, and so forth), a single physical network may be sliced into multiple virtual networks that can support different radio access networks (RANs), or different service types running across a single RAN. Network slicing may primarily be used to partition the core network, but it may also be implemented in the RAN. Network slicing may need to account for hardware constraints such as quantum key distribution, satellites, etc.

In one network slicing example, an autonomous car may rely on V2X (vehicle-to-anything) communication which requires low latency but not necessarily a high throughput. A streaming service watched while the car is in motion may require a high throughput and is susceptible to latency. Both would be able to be delivered over the same common physical network on virtual network slices to optimize use of the physical network.

Network slicing maximizes the flexibility of time sensitive networks, optimizing both the utilization of the infrastructure and the allocation of resources. This enables greater energy and cost efficiencies compared to earlier time sensitive networks. TSN messages can be protected by quantum key distribution as well as support deterministic quantum key distribution processing.

Each virtual network (network slice) comprises an independent set of logical network functions that support the requirements of the particular use case, with the term ‘logical’ referring to software.

Each virtual network may be optimized to provide the resources and network topology for the specific service and traffic that will use the slice. Functions such as speed, capacity, connectivity and coverage may be allocated to meet the particular demands of each use case, but functional components may also be shared across different network slices.

Each virtual network may be completely isolated so that no slice can interfere with the traffic in another slice. This lowers the risk of introducing and running new services, and also supports migration because new technologies or architectures can be launched on isolated slices. Network slicing also has a security impact, because if a cyber-attack breaches one slice the attack is contained and not able to spread beyond that slice. In some embodiments, quantum key distribution may be used to isolate slices, thereby providing further protection.

Each network slice may be configured with its own network architecture, engineering mechanism, and network provisioning. Each network slice may typically contain management capabilities, which may be controlled by the network operator or the customer, depending on the use case. Each network slice may be independently managed and orchestrated. The user experience of each network slice may be the same as if the slice were a physically separate network. A “virtual slice” of a quantum key distribution system may be implemented in different ways, including multiplexing the quantum channel to generate keys for different users on separate time slots or frequencies. In other words, quantum key distribution may be sliced by running several logical quantum channels in the same fiber, by either time multiplexing or frequency multiplexing the quantum channels, such slices may be referred to as quantum key distribution network slices.

Network slicing may be optimized for time sensitive networks employing 5G services. For example, in 5G end-to-end (E2E) autonomous network slicing, different network slices can be created automatically and in an optimized way on a shared RAN, core, and transport network.

In some embodiments, the wireless communication system 100 may include functionality to implement quantum-secure communications using quantum cryptography and/or quantum key distribution. Traditional cryptography relies on the computational difficulty of mathematical functions and employs mathematical techniques to restrict eavesdroppers from learning the contents of encrypted messages. Quantum key distribution differs from traditional cryptography in that it relies on physics to achieve the same objectives. Quantum key distribution allows communicating users to detect the presence of a third party trying to gain knowledge of the encryption key. What the eavesdropper can measure, and how, depends exclusively on the laws of physics. Further, because traditional cryptography requires computational complexity for security, it requires more compute time for stronger protection. For quantum-resistance, traditional cryptography may take too long to be useful for industrial control applications and may not be suitable for deterministic communication such as TSN.

In some implementation, a network slice may be associated with at least one of the quantum keys. Network slices may reside over satellite 130, which may serve as a quantum key distribution satellite. Such slices may be referred to as “quantum key distribution network slices” for delivering quantum keys. In other words, a network slice may be defined purely to distribute quantum keys. Stated yet another way, a network slice may be set up through a satellite, and that network slice may be dedicated to distributing (or supporting the distribution of) quantum key distribution keys.

Quantum key distribution may use a classical (non-quantum) channel and a quantum channel. One or both of the classical and quantum channels may be “sliced” via time or frequency multiplexing. Each such slice (representing the classical or quantum channel) may be associated with, and act as, part of a network slice implemented in a 5G network and may support TSN or may be TSN-implemented. The classical channel may support the quantum channel because there is some classical processing and exchanges that occur as part of quantum key distribution. These channels may be implemented over dedicated slices. Once a final quantum key is generated, the quantum key may be distributed over a respective dedicated slice and if the 5G network support TSN flows, the quantum key may be distributed over a TSN flow within the 5G network in order to provide keys at precise, deterministic, periodic, intervals. Since quantum key distribution is a physical process (involving the use of hardware to generate and distribute quantum keys) and network slices are virtual (involving software and virtualized abstractions), it is desirable to keep encryption keys in a quantum state and localized to respective devices until needed in order to avoid vulnerabilities inherent in passing classical keys around. In some implementations, quantum memory may be used to store cubit results of a prior exchange over the quantum channel until keys are needed.

In some implementation, in a 5G network with TSN implementation (i.e., supporting TSN flows through the 5G network), quantum keys (classical keys created via quantum key distribution) may be transmitted via TSN such that keys are delivered according to a precisely-defined, period schedule that matches the required time for key updates at a TSN Listener. In some implementations, the QKD classical channel may be implemented over TSN over 5G as well, providing deterministic control within the QKD system as well as avoiding denial of service on the classical channel.

Satellites can have both a 5G-user plane and control plane. Both planes require security for their protocol stacks. The satellite radio interface (SRI) may also be secured using quantum key distribution. Quantum key distribution can be used at any interface, and at any layer, depending on performance constraints. Similar to the concept of transparent satellites, there can be transparent quantum key distribution. Quantum key distribution may be implemented at a very low level (e.g., at the RF level). For example, quantum key distribution may be implemented at the modulation scheme itself, including sending modulated symbols over the air. The symbols can be encrypted with quantum key distribution, and the receiver would be required to decrypt them to get individual symbols. This would be extremely secure, but at the cost of performance.

According to an example embodiment, photon transmission may be utilized to distribute or exchange keys between devices. Once the keys are exchanged securely, normal operation can take place using any traditional protocol, including radio frequency. Example embodiments provide a mechanism for quantum key exchange and/or distribution that minimizes equipment cost for the utility while maintaining communications security. In some embodiments, quantum key distribution requires both classical channels (also referred to as service channels) and quantum channels. The 5G network can provide the classical channel for quantum key distribution. URLLC and/or TSN may be used for a highly reliable and deterministic quantum key distribution classical channel. The quantum channels may be provided as discussed herein (e.g., using quantum key distribution slices). In some embodiments, for a given communication, the quantum key distribution classical channel is in parallel with the quantum key distribution quantum channel.

Example embodiments may utilize optical communication channels to distribute or exchange symmetric quantum keys (or alternatively, quantum random-generated numbers) so that the UE 120 and the subcomponents 112-118 of the wireless communication network 110 can encode and decode data between each other. In some implementation, the quantum keys (or alternatively, quantum random-generated numbers) may be used at the physical layer of the network layer stack of the network 110, e.g., as part of antenna control and modulation techniques at the physical layer of the network stack, or as part of network coding (a form of source code compression that requires random input to ensure proper matrix rank—maximum number of linearly independent column vectors in the matrix). For instance, the wireless communication system 100 may include a wireless key distribution device, e.g., satellite 130. Satellites can provide a common source of entanglement to a wide variety of ground-based receivers enabling them to make quantum measurements using random bases. For example, in a future 5G+ (6G) network that implements network slicing via entanglement, users in the same slice may share entangled states. Specifically, a slice may be implemented as a multipartite quantum entanglement among the members of the slice. This entanglement can be used in the generation of quantum keys, among other applications. However, maintaining entanglement may be error-prone, and QKD includes a sifting and reconciliation process to handle quantum bit errors. In some embodiments, entanglement may occur through a common device, such as a satellite.

Satellites typically XOR keys that are individually generated between ground stations. The XORed key is distributed so the either ground station can decode. In another instance, quantum key distribution methods may include a quantum interface or quantum channel between subcomponents of the wireless communication network 110 and the UE 120. The quantum interface may be a physical fiber optic interface. The quantum interface may be offered as a service to provide quantum keys to user equipment via fiber end points for mobile use at instantiation of communications between the UE 120 and the wireless communication network 110.

According to an example embodiment, a quantum key distribution link may connect two stations: Alice and Bob, The quantum key distribution link may be “transparent” in terms of providing seamless security between links carrying 5G information. Quantum key distribution may support both encryption and integrity protection or each separately. Authentication may be implemented by integrating a post-quantum crypto algorithm with the quantum key distribution end-station hardware. In an example embodiment, Alice may initiate communication by encoding information in entangled single-photon states, while Bob tries to detect the photons and decode their state. According to an example embodiment, the entanglement-based communication schemes may involve photon pair production and entanglement. Example embodiments may include systems having high-power pump lasers and a multitude of single-photon detectors. Other example embodiments may include inexpensive laser diodes operating in the gain-switched regime and attenuated to a sub-photon per pulse level. In accordance with certain example embodiments, the system may be simplified to include a single Alice that can communicate with multiple Bob's, who can either detect a photon or simply redirect it to the next station. Alternatively, a single Bob can receive photons from multiple Alices. Stated another way, the satellite sets up a quantum key distribution to ground stations and XORs the keys that it distributes. The satellite sets up a specific key between the satellite and ground station A (Alice), and sets up another key between the satellite and ground station B (Bob). The satellite XORs station A's key with station B's key and sends it out so that each ground station can perform the XOR again to retrieve the other ground station's key. As such, each ground station can put the keys together by XORing and then subtract them by XORing. In some implementations, in addition to or as an alternative to quantum key distribution, the satellite may perform post-quantum cryptography. In some embodiments, for scenarios in which there may be intermittent connectivity, quantum memory is used to store the keys. Specifically, the network holds quantum bits in memory within both Alice and Bob ground stations and performs all classical steps later when needed.

In some embodiments, during network slice configuration, the physical fiber interface may be offered as a resource or service to securely create the symmetric quantum keys. Quantum key distribution may serve keys as a client-subscriber system for applications and higher protocol layers. However, quantum key distribution may also provide seamless security underneath the protocols as discussed above. As such, the system may be a quantum key distribution server (a key server). Applications may obtain keys at both ends of a given link. Stated another way, 5G systems may offer quantum key distribution as a service, providing keys in a client subscriber paradigm to applications.

In some embodiments, the systems described herein securely and efficiently interface equipment connected to a quantum-protected wired network (e.g., TSN) with a quantum-protected wireless (e.g., 5G) network to allow for secure communications that avoid eavesdropping. In some embodiments, continuous-variable quantum key distribution (CV-QKD) photon distribution may be implemented using MIMO antennas. In some embodiments, quantum programmable interface controllers (PIC) chips may be integrated into 5G devices.

FIG. 1B illustrates another view of the wireless communication system 100 according to an embodiment of the disclosure. Items in FIG. 1B that correspond to items in FIG. 1A are similarly numbered and may be configured to function as discussed above. For purposes of brevity and so as not to obscure the inventive concepts, these features will not be further discussed with reference to FIG. 1B.

The wireless communication system 100 in FIG. 1B may include a wireless communication network 110. The wireless communication network 110 is configured to provide wireless communication functionality as described in further detail herein. The wireless communication network 110 may be implemented as a radio access network (RAN). The satellite 130 may be included in the RAN, generating and/or distributing quantum key distribution keys to and between UE 120 and RU 112. As an alternative or in addition to satellite 130, quantum data on the quantum channel between UE 120 and RU 112 may be communicated via a free-space optical communication device, millimeter wave communication device, microwave communication device, visible light communication device, or the like.

FIG. 1C illustrates a wireless communication system 150 according to an embodiment of the disclosure. Items in FIG. 1C that correspond to items in FIGS. 1A and 1B are similarly numbered and may be configured to function as discussed above. For purposes of brevity and so as not to obscure the inventive concepts, these features will not be further discussed with reference to FIG. 1C.

The wireless communication system 150 in FIG. 1C may include a wireless communication network 110. The wireless communication network 110 is configured to provide wireless communication functionality as described in further detail herein. The wireless communication network 110 may be implemented as a radio access network (RAN).

In wireless communication system 150, one or more of the USIM, the gNB, the RU 112, the DU 114, and the CU 116 reside on (are included in) the satellite 130. In such a configuration, satellite 130 is part of the framework of the wireless communication network 110, and in addition to distributing quantum keys as discussed above with reference to FIG. 1A, satellite 130 passes both quantum data on a quantum channel (including quantum encryption keys) and classical data on a service channel (including user data, configuration data, 5G NR-Uu information, and communications in general). In such a configuration, network 110 can perform single-photon emission and detection of the quantum data. In some implementations, 5G components (e.g., the gNB, the RU 112, the DU 114, and the CU 116) on board the satellite 130 may receive a key while a terrestrial UE 120 receives the other corresponding key. Thus, only one key need be transmitted by the satellite 130 to ground (as opposed to the usual two keys).

Thus, FIGS. 1A-1C illustrate at least three embodiments. In one embodiment, satellite 130 may act as a pass-through for quantum information (e.g., quantum encryption keys), while classical data (e.g., user data) is transmitted directly between the UE 120 and the RU 112, as shown in FIG. 1A. In another embodiment, satellite 130 is part of RAN of the 5G network may act as a pass-through for both quantum information and classical data; in such an embodiment, the UE 120 connects to satellite 130, and satellite 130 connects to the 5G network core through an NTN gateway (as shown in FIGS. 1B and 1C). In another embodiment, satellite 130 hosts the RU 112, the DU 114, and/or the CU 116 (and/or other components of the 5G network), passes both quantum data and user data; in such an embodiment, satellite 130 is part of the 5G network. In any of these embodiments (e.g., corresponding to any of FIGS. 1A-1C), quantum key distribution may be added to any of the links between any of the labeled items in order to protect the information flow all the way through the system. For example, quantum key distribution may be added between the UE 120 and the satellite 130, between the satellite 130 and the RU 112, between the DU 114 and the CU 116, between the CU 116 and the 5GC 118, and/or between the UE 120 and the RU 112.

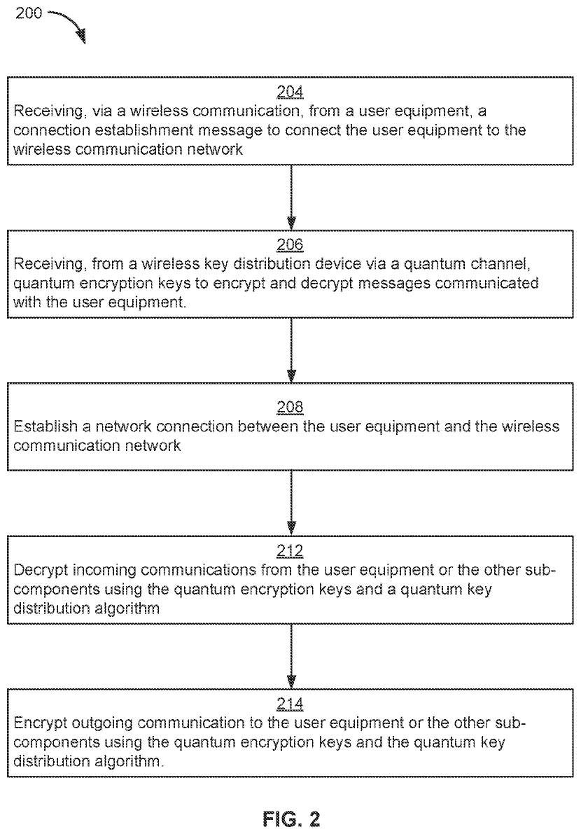

In FIG. 2, there is shown a flow chart illustrating a method 200 of implementing quantum-secure wireless communications using network 110 and/or network 150.

In some embodiments, and for ease of understanding, aspects of method 200 may be performed by a wireless communication network 110 in conjunction with satellite 130. The wireless communication network 110 may include subcomponents such as RU 112, DU 114, CU 116 and/or 5GC 118. However, in other embodiments, at least some aspects may be performed by other components of the wireless communication system 100.

At step 204, a connection establishment message from user equipment 120 via a wireless communication channel is received by a wireless communication network 110. The connection establishment message is configured to connect the user equipment 120 to the wireless communication network 110. The connection includes creation of a network slice on the wireless communication network 110 as described herein.

At step 206, quantum encryption keys are received by a wireless communication network 110 from a wireless key distribution device (e.g., satellite 130) via a quantum channel. The quantum channel may be a fiber optic channel. The quantum channel may be a communication channel which can transmit quantum information, as well as classical information. An example of quantum information is the state of a qubit. An example of classical information is a text document transmitted over the Internet. In some embodiments, a quantum channel is a completely positive (CP) trace-preserving map between spaces of operators. In other words, a quantum channel is just a quantum operation viewed not merely as the reduced dynamics of a system but as a pipeline intended to carry quantum information. The quantum encryption keys may be utilized to encrypt or decrypt messages communicated with the user equipment 120 as described herein.

In some embodiments, in addition to distributing the quantum encryption keys to a wireless communication network 110, the quantum encryption keys may also be distributed to the user equipment 120 for further use by the user equipment 120 to encrypt/decrypt wireless communications.

At step 208, a network connection is established between the user equipment 120 and the wireless communication network 210.

At step 212, for at least one subcomponent of the wireless communication network 110, decrypt incoming communications from the user equipment 120 or the other subcomponents using the quantum encryption keys and a quantum key distribution algorithm, as described herein. In some embodiments, each subcomponent of the wireless communication network 110 may optionally be configured to decrypt incoming communications from the user equipment 120 or the other subcomponents.

At step 214, for at least one subcomponent of the wireless communication network 110, encrypt outgoing communication to the user equipment or the other subcomponents using the quantum encryption keys and the quantum key distribution algorithm, as described herein. In some embodiments, each subcomponent of the wireless communication network 110 may optionally be configured to encrypt incoming communications from the user equipment 120 or the other subcomponents.

In some embodiments, a network connection may be established between the user equipment 120 and the wireless communication network 110 using a network slice configuration. The quantum keys may be network-slice specific. Each subcomponent of the wireless communication network 110 may encrypt/decrypt communications using the quantum keys that are specific to the network slice.

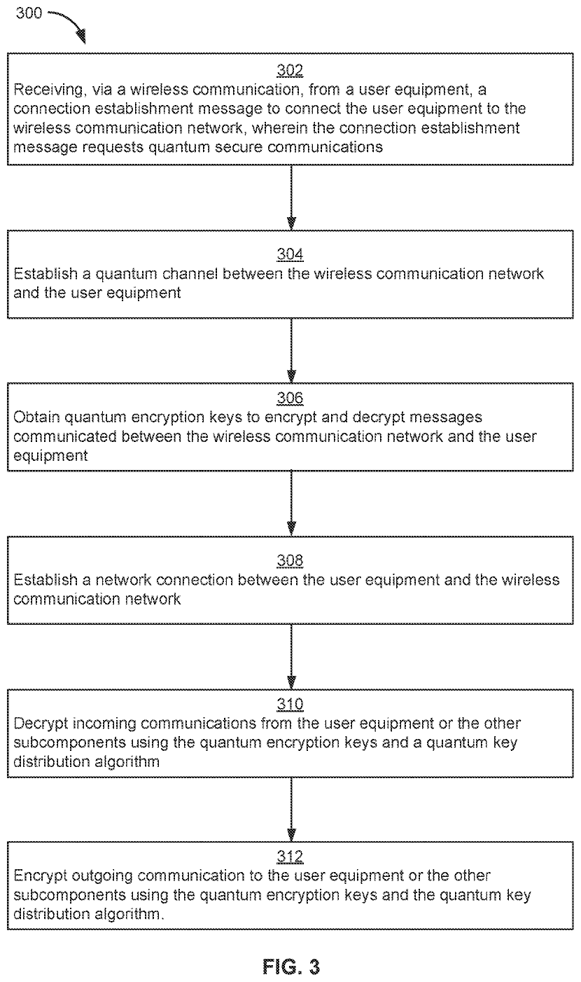

In FIG. 3, there is shown a flow chart illustrating a method 300 of implementing quantum-secure wireless communications using network 110 and/or network 150.

In some embodiments, and for ease of understanding, aspects of method 300 may be performed by a wireless communication network 110. The wireless communication network 110 may include subcomponents such as RU 112, DU 114, CU 116 and/or 5GC 118. However, in other embodiments, at least some aspects may be performed by other components of the wireless communication system 100.

At step 302, a connection establishment message is received via a wireless communication from UE 120 to connect the UE 120 to the wireless communication network 110. In some embodiments, the connection establishment message requests quantum secure communications.

At step 304, a quantum channel is established between the wireless communication network 110 and the UE 120, as described herein, In some embodiments, the quantum channel is a physical fiber optic channel between the wireless communication network and the user equipment. In some embodiments, establishing a quantum channel between the wireless communication network 110 and the UE 120 includes providing a service function to establish the quantum channel.

At step 306, quantum encryption keys are obtained to encrypt and decrypt messages communicated between the wireless communication network 110 and the UE 120. In some embodiments, quantum encryption keys are transmitted or distributed via the quantum channel to the UE 120 for further cryptographic communications.

At step 308, a network connection is established between the wireless communication network 110 and the UE 120, as described herein.

At step 310, at least one subcomponent of the wireless communication network 110 (and in some embodiments, all subcomponents) decrypts incoming communications from the user equipment or the other subcomponents using the quantum encryption keys and a quantum key distribution algorithm, as described herein.

At step 312, at least one subcomponent of the wireless communication network 110 encrypts outgoing communication to the user equipment or the other subcomponents using the quantum encryption keys and the quantum key distribution algorithm, as described herein.

In at least one embodiment, there is included one or more computers having one or more processors and memory (e.g., one or more nonvolatile storage devices). In some embodiments, memory or computer readable storage medium of memory stores programs, modules and data structures, or a subset thereof for a processor to control and run the various systems and methods disclosed herein. In one embodiment, a non-transitory computer readable storage medium having stored thereon computer-executable instructions which, when executed by a processor, perform one or more of the methods disclosed herein.

It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention, different components as opposed to those specifically mentioned may perform at least some of the features described herein, and features of the disclosed embodiments may be combined. As used herein, the terms “about” and “approximately” may refer to + or −10% of the value referenced. For example, “about 9” is understood to encompass 8.2 and 9.9.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

It will be understood that, although the terms “first,” “second,” etc. are sometimes used herein to describe various elements, these elements should not be limited by these terms. These terms are only used to distinguish one element from another. For example, a first element could be termed a second element, and, similarly, a second element could be termed a first element, without changing the meaning of the description, so long as all occurrences of the “first element” are renamed consistently and all occurrences of the second element are renamed consistently. The first element and the second element are both elements, but they are not the same element.

As used herein, the term “if” may be, optionally, construed to mean “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or evert]” or “in response to detecting [the stated condition or event]” or “in accordance with a determination that [a stated condition or event] is detected,” depending on the context.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also he understood that the term “and/or” as used herein refers to and encompasses any and all possible combinations of one or more of the associated listed items. It will be further understood that the terms “comprises” and/or “comprising,” when used in this specification, specify the presence of stated features, integers, operations, elements, and/or components, but do not preclude the presence or addition of one or more other features, integers, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

Further, to the extent that the method does not rely on the particular order of steps set forth herein, the particular order of the steps should not be construed as limitation on the claims. The claims directed to the method of the present invention should not be limited to the performance of their steps in the order written, and one skilled in the art can readily appreciate that the steps may be varied and still remain within the spirit and scope of the present invention.

1. A method of quantum-secure communications, comprising:
at a wireless communication network including subcomponents, each subcomponent being communicatively coupled to at least one other subcomponent:
receiving, via a wireless communication, by the wireless communication network, from a user equipment, a connection establishment message to connect the user equipment to the wireless communication network;
receiving, from a wireless key distribution device via a quantum communication channel, quantum encryption keys to encrypt and decrypt messages communicated with the user equipment, wherein the quantum communication channel is established for distributing the quantum encryption keys to the user equipment and the subcomponents;
establishing a network connection between the user equipment and the wireless communication network; and
for at least one subcomponent of the wireless communication network:
decrypting incoming communications from the user equipment or the other subcomponents using the quantum encryption keys and a quantum key distribution algorithm; and
encrypting outgoing communication to the user equipment or the other subcomponents using the quantum encryption keys and the quantum key distribution algorithm.

2. The method of claim 1, further comprising: distributing, via the wireless key distribution device in the wireless communication network, the quantum encryption keys to the user equipment.

3. The method of claim 1, wherein the subcomponents of the wireless communication network include a radio unit, a distribution unit, a control unit and a core network.

4. (canceled)

5. (canceled)

6. The method of claim 1, wherein the wireless communication network includes a plurality of network slices, wherein each network slice is associated with at least one of the quantum encryption keys.

7. The method of claim 6, further comprising:
establishing the network connection between the user equipment and the wireless communication network using a first network slice of the plurality of network slices; and
for the at least one subcomponent of the wireless communication network:
decrypting incoming communications from the user equipment or the other subcomponents using the at least one of the quantum encryption keys associated with the first network slice and the quantum key distribution algorithm; and
encrypting outgoing communication to the user equipment or the other subcomponents using the at least one of the quantum encryption keys associated with the first network slice and the quantum key distribution algorithm.

8. (canceled)

9. (canceled)

10. A method, comprising:
receiving, via a wireless communication, from a user equipment, a connection establishment message to connect the user equipment to a wireless communication network, wherein the connection establishment message requests quantum secure communications;
establishing a quantum channel between the wireless communication network and the user equipment for distributing quantum encryption keys to the user equipment and subcomponents of the wireless communication network;
obtaining the quantum encryption keys to encrypt and decrypt messages communicated between the wireless communication network and the user equipment;
providing the quantum encryption keys to the wireless communication network or the user equipment via the quantum channel;
establishing a network connection between the user equipment and the wireless communication network;
for at least one subcomponent of the wireless communication network:
decrypting incoming communications from the user equipment or the other subcomponents using the quantum encryption keys and a quantum key distribution algorithm; and
encrypting outgoing communication to the user equipment or the other subcomponents using the quantum encryption keys and the quantum key distribution algorithm, wherein at least one of the quantum encryption keys is associated with each of a plurality of network slices of the wireless communication network.

11. The method of claim 10, wherein the quantum channel is a physical fiber optic channel between the wireless communication network and the user equipment.

12. The method of claim 10, wherein establishing a quantum channel between the wireless communication network and the user equipment includes providing a service function to establish the quantum channel.

13. The method of claim 10, further comprising: distributing, via a wireless key distribution device and the quantum channel, the quantum encryption keys to the user equipment.

14. The method of claim 10, wherein each subcomponent is configured to encrypt and decrypt communications using the quantum encryption keys and the quantum key distribution algorithm.

15. (canceled)

16. The method of claim 10, further comprising:
establishing the network connection between the user equipment and the wireless communication network using a first network slice of the plurality of network slices; and
for at least one subcomponent of the wireless communication system network:
decrypting incoming communications from the user equipment or the other subcomponents using the at least one of the quantum encryption keys associated with the first network slice and the quantum key distribution algorithm; and
encrypting outgoing communication to the user equipment or the other subcomponents using the at least one of the quantum encryption keys associated with the first network slice and the quantum key distribution algorithm.

17. (canceled)

18. (canceled)

19. The method of claim 1, wherein at least one of the quantum encryption keys is configured to support time deterministic communication in a dedicated network slice among a plurality of network slices.

20. The method of claim 10, wherein the at least one of the quantum encryption keys is configured to support time deterministic communication in a dedicated network slice among the plurality of network slices.

21. The method of claim 1, wherein the wireless communication network is compatible with a 3GPP standard.

22. The method of claim 10, wherein the wireless communication network is compatible with a 3GPP standard.

23. The method of claim 1, wherein the quantum encryption keys are used for at least one of antenna control and symbol modulation in the wireless communication network.

24. The method of claim 10, wherein the quantum encryption keys are used for at least one of antenna control and symbol modulation in the wireless communication network.

25. A system, comprising:
a wireless key distribution device configured to distribute quantum encryption keys to a user equipment and subcomponents of the wireless communication network via a quantum communication channel to encrypt and decrypt messages communicated with the user equipment, wherein the quantum communication channel is established for distributing the quantum encryption keys to the user equipment and the subcomponents; and
at least one of the subcomponents of the wireless communication network configured to:
decrypt incoming communications from the user equipment or the other subcomponents using the quantum encryption keys and a quantum key distribution algorithm; and
encrypt outgoing communication to the user equipment or the other subcomponents using the quantum encryption keys and the quantum key distribution algorithm.

26. The system of claim 26, wherein at least one of the quantum encryption keys is configured to support time deterministic communication in a dedicated network slice among a plurality of network slices.

27. The system of claim 27, wherein the wireless communication network is compatible with a 3GPP standard.
